(19) United States
(12) Patent Application Publication
(10) Pub. No.: US 2014/0089786 A1
(43) Pub. Date: Mar. 27, 2014

(54) Automated Processor For Web Content To Mobile-Optimized Content Transformation

(71) Applicant: Atiq Hashmi, Sayerville, NJ (US)

(72) Inventor: Atiq Hashmi, Sayerville, NJ (US)

(21) Appl. No.: 14/094,191

(22) Filed: Dec. 2, 2013

Related U.S. Application Data
(63) Continuation-in-part of application No. 13/908,536, filed on Jun. 3, 2013.
(60) Provisional application No. 61/654,225, filed on Jun. 1, 2012.

(51) Int. Cl. G06F 17/22

(52) U.S. Cl. CPC G06F 17/2247
USPC 715/234

(57) ABSTRACT

A system, method, and apparatus for dynamically and automatically transforming desktop web content into a mobile-optimized version for consumption by a variety of mobile devices. The system is delivered as SaaS (Software as a Service) platform on a hosting server. Input may be provide by a user who interacts with the system by simply entering a website address, or may be provided in an automated way using a software programming interface method. The system creates the mobile-optimized version that can optionally be cached and served to mobile devices.

### CLAIM OF PRIORITY

This application is a continuation-in-part of U.S. application Ser. No. 13/908,536 entitled “A Mobile Content Management System” filed on Jun. 3, 2013, which claims priority to U.S. Application 61/654,225 entitled “A Mobile Content Management System” filed on Jun. 1, 2012 the contents of both are hereby incorporated by reference in their entirety.

### FIELD OF THE INVENTION

The field of the invention relates to a web based engine that optimizes web content for the mobile platform. In particular, the current invention provides a streamlined, cost effective solution for seamlessly creating sites for mobile platforms based on the corresponding website.

### BACKGROUND OF THE INVENTION

### Problem to be solved

Creating a website or web content portal requires a complete cycle of graphic design, HTML and JavaScript coding with CSS styling, and testing the developed site. This cycle involves using few tools, for example, to create graphic elements, or creating page content one by one. Most of this work is done manually. To create a mobile-optimized website, a similar cycle is involved. However, in most cases, a mobile website is either a replica or closely matching version of the desktop website. Additionally, sometimes special parts of a large web portal may be selectively used for a mobile-optimized site or resource. For most businesses, this means incurring costs in terms of duplicating the effort and money. This document describes a method, system and apparatus to automate the conversion and creation of the websites without manual effort thus virtually eliminating the costs of labor and time.

The arrival of mobile devices in the last decade that can receive and process data has provided users on the go the ability to receive information (besides making phone calls) on their mobile devices.

The smartphone and iPad introduction has created a new industry of mobile computing and application development. A major use of the smartphones is to download and run applications that are built for the device's native platforms. Another major use of the smartphones is the ability to access and browse full websites. Advanced phones built on iOS, Android, etc. have zoom, pinch, and pan capabilities that allow viewing the full website content. However, as more and more users are using their smartphones on a regular basis, doing this for every website and every page of each website is very tedious and time consuming. Therefore, in the last few years, a trend has developed about optimizing regular desktop websites into mobile compatible versions for easy interaction and efficiency as well new features now possible with various hardware capabilities of these phones.

Creating a mobile optimized version involves technical know-how in the mobile web design. It involves learning a significant amount of new concepts and technology to develop fully functional and well-performing websites that work on the mobile devices.

For businesses and individuals, gaining the know-how to create mobile optimized versions of their websites is a challenge. In the desktop website world, which has been around for two decades, many tools and platforms have been developed that allow users of moderate web or technology savvy to build their websites themselves. These tools have some supported plug-ins or modules to cater to mobile devices, but are at best plug-ins and not comprehensive tools. At the same time, in the mobile world, very few such tools exist that are mobile specific.

Mobile branding is a growing need for businesses today, and staying behind the curve may prove costly in terms of lost market share. While there are some tools available today, they still require significant manual work. Most small and medium sized businesses find themselves unable to find the time or focus to learn and use such tools. At the same time, engaging a professional to build the mobile presence is costly. Therefore, a significant need exists to provide an easy, quick and a cost effective system that allows for businesses and individuals to build and maintain their mobile presence and brand. The invention described in this document addresses these needs as well as other features.

Reviewing of related technology:
a. U.S. Pat. No. 8,321,359 B2 titled “Mobile Website Optimization” suggests a patent on web content optimization, but it's not mobile related and only addresses website performance.
b. WO2011150291 A1 titled “Advertising and mobile site builder” covers a template based builder to create advertisement and content for mobile devices. It does not address the automated and dynamic conversion from desktop to mobile web content.
c. U.S. Pat. No. 8,321,502 titled “Method for optimizing a web content proxy server and devices thereof”. This patent discusses using a proxy server between client devices and web server and optimizing cookies for maintaining sessions. It does not relate to web page content conversion for rendering to mobile devices.
d. U.S. Pat. No. 8,196,035 titled “Adaptation of a website to mobile web browser” covers conversion of the content using a snapshot version and a design layer. While it generally covers the web site to mobile conversion, our invention differs in multiple and novel ways. For example, this invention proposes a caching capability for the generated mobile website such that upon the request from a client mobile device, the statically saved version is simply returned providing a better performance. Our invention utilizes a flexible and extensible catalog approach to support new web content structures, provides support for plug-in modules that can aid in handling variety of rich web content data, supports a recursive method to support any number of pages and depth of navigational hierarchy, as well as ability to serve as a core engine for a variety of transformation needs and not just for website conversions to mobile.
e. PCT/US2007/076260 provides a method of parsing web content and making it available for selection, exclusion using a configuration module where specific tags from a library can be chosen to be included in the resulting mobile output. This is a very different and tedious approach. Our invention provides a simple automated conversion of existing web content with more focus on automation and dynamic transformation than dealing with tag level manipulation etc.
f. U.S. application Ser. No. 12/911,689 titled “Configurable and Dynamic Transformation of web content” also suggests a lengthy and low level transformation setup by an operator. Our invention handles content at a low level but provides a simple abstraction for intuitive user level objects such as logo, banner etc.
g. U.S. application Ser. No. 13/342,969 titled “Automated generation of mobile optimized website” addresses mobile optimization from a website that is created by an existing website authoring tool (probably their own) and thus having web content assets in a known format in the storage. The web conversion process then takes those and converts them using mobile formatting. That approach is radically different from our invention. Their approach does not address converting ‘any’ website on the web and attempting to convert.

Various devices are known in the art. However, their structure and means of operation are substantially different from the present disclosure. The other inventions fail to solve all the problems taught by the present disclosure. The present invention employs a novel approach that extends beyond simply converting a website to a mobile platform. At least one embodiment of this invention is presented in the drawings below and will be described in more detail herein.

### SUMMARY OF THE INVENTION

A system, method, and apparatus for an automatic detection and extraction of content-sections of a web content source such as a website and conversion into a mobile-ready format suitable for display and use on a mobile device such as a smartphone, tablet or other mobile devices with various form factors and screen sizes is described and taught. The system, method, and apparatus, referred to in this document as Website-to-Mobile-Website Converter (also referred to as WMC), are described. The core processing engine that has the intelligence to perform the conversion is referred to Mobile Conversion Engine (also referred to as MCE) in this document. The output of the WMC is referred to as Mobile Website (MW).

The method may include taking an input parameter from an entity like a user of the WMC software or another source, the parameter possibly being a specific Uniform Resource Locator (or URL for short), such as a website address like http://www.examplepage.com, and communicating with it to fetch its content and assets including but not limited to a plurality of images, navigation links, rich content coded in HTML etc.

It is an object of the invention to provide a system and apparatus for automated and dynamic transformation of desktop web content into a mobile-optimized web content suitable for displaying and interaction on a mobile device, having a web to mobile conversion server having a mobile conversion engine and a storage module, wherein the mobile conversion engine is capable of creating a new mobile-optimized web content from existing desktop web content, wherein the mobile conversion engine further comprises, a content analyzer capable of understanding and parsing the desktop website content, identifying the content-sections and manipulating it, wherein the content analyzer has the ability to serve as a middle layer processor between two systems, receiving web content from a source, performing the conversion, and passing the resulting mobile-optimized content to another system.

It is an object of the invention to provide a method, implemented by the content analyzer, for parsing the desktop web content comprising the steps of: detecting various structural attributes; performing a variety of computing operations on the structural attributes to extract desired content-sections; and combining the content sections into a useful and meaningful mobile-optimized content.

It is another object of the invention to provide a method of supporting a variety of rich content features and utility tools by utilizing a plurality of plug-ins such as for image gallery, images slider, or generating advertisement flash pages or the like or any combination thereof.

### BRIEF DESCRIPTION OF THE DRAWINGS

FIG. 1 is a high level block diagram of an exemplary system from a user interface flow perspective of the present invention.

FIG. 2 is a block diagram showing an embodiment and important components of the high level exemplary system in FIG. 1.

FIG. 2A is represents an exemplary mobile optimized website layout.

FIG. 3 is a block diagram showing an embodiment of the typical website content-sections that are to be detected in a desktop website and extracted for presenting in the resulting mobile website. Other embodiments of the types of content-sections and layouts are possible.

### DETAILED DESCRIPTION OF THE INVENTION

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

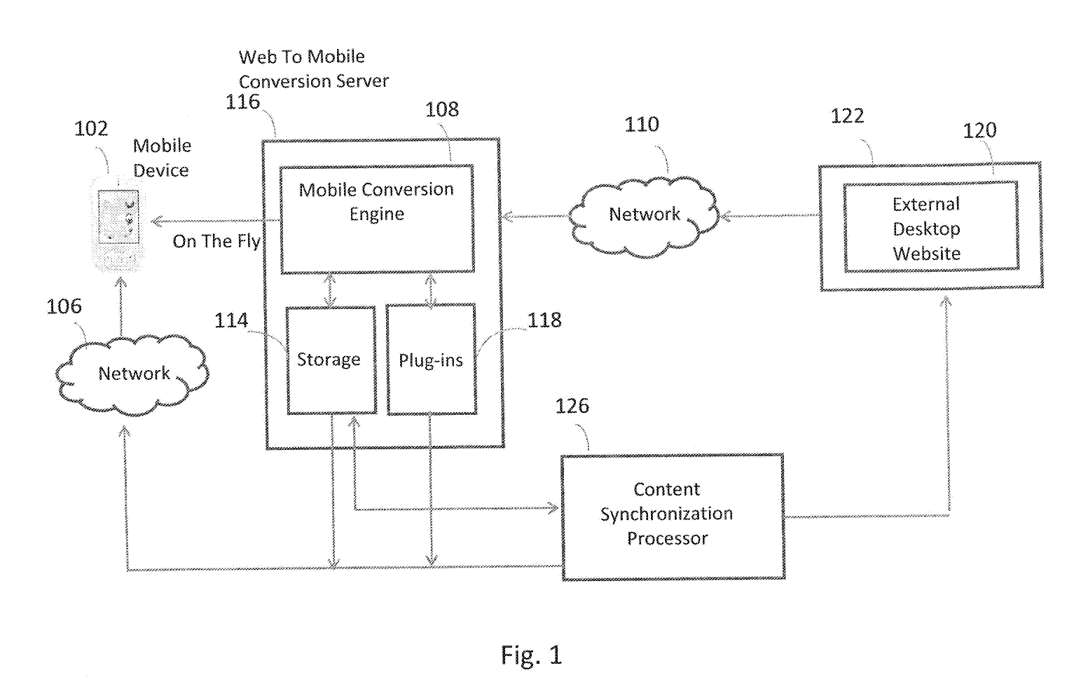

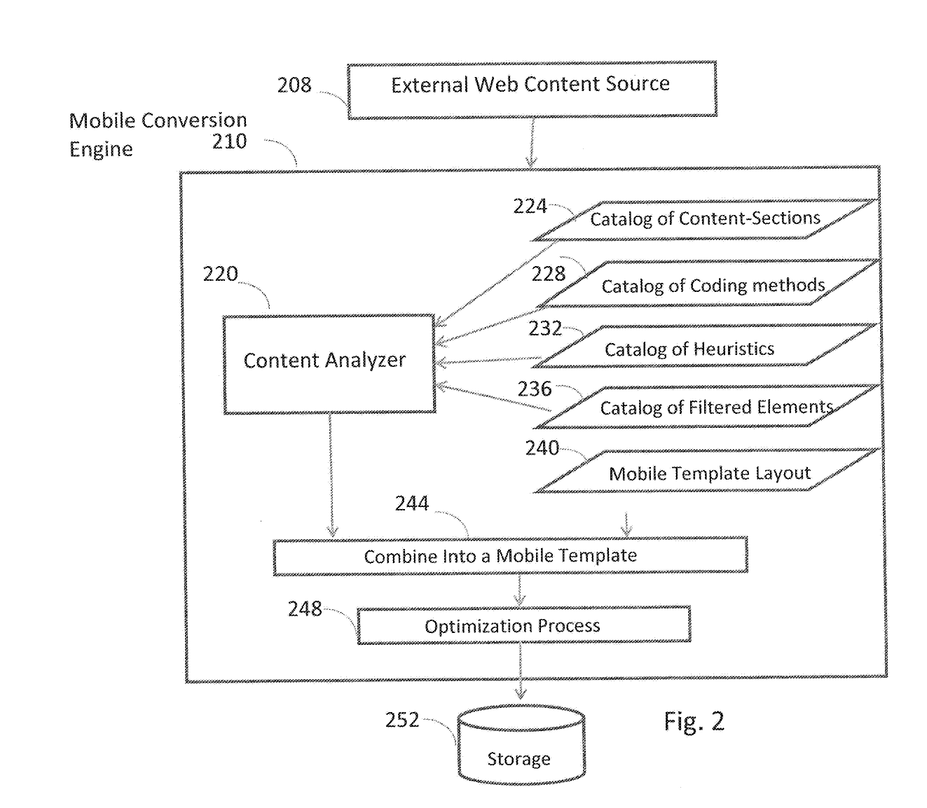

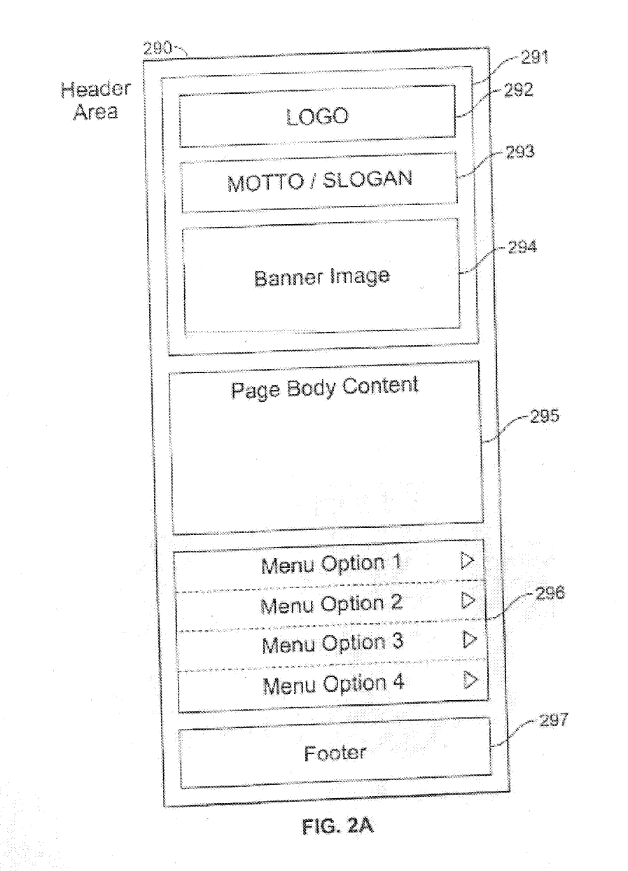

FIG. 1 is a block diagram showing an exemplary system. FIG. 1 describes various high level components. In one embodiment, the WMC 116 may be used by a human operator. In another embodiment, another software system may serve as an automated content input source where the Web to Mobile Conversion (WMC) server 116 may be configured to receive and act on the content without human intervention. The MCE 108 which runs on a WMC server 116 and is a software system comprising of several processing components as depicted in FIG. 2 and will be described in more detail in the subsequent paragraphs. The mobile device 102 connects with WMC Server 116 and gets mobile/web (MW) content over a network 106 which may include of a variety of telecommunications (wireless e.g. EDGE/GPRS, GSM, HSPA etc. and wired e.g. SS7, SONET, ATM etc.) and data networks, e.g. Internet Protocol network, Ethernet, Wi-Fi etc. capable of transporting the web content between the MCE 108 and the mobile device 102. In another embodiment, the web server 122 may be a local source on the local file system containing the content that needs to be processed for generating a mobile optimized output.

The MCE 108 has the intelligence to understand web content structure that may be published in a web publishing language such as HTML, and optimize the content in a format suitable for use on mobile devices. In one embodiment, the MCE 108 may generate mobile-optimized content and save it in the Storage 114 which is part of the WMC server 116, but may reside outside of it. The storage 114 may consists of any physical and logical data storage medium such as one or more databases and file systems etc. The database may consist of any form of data management system such as a Relational or Non-Relational Database Management System (RDBMS), whereas the file system may consist of any kind of file organization structure, such as FAT32, NTFS, AFS etc. suitable to store MW content. The Content Synchronization Processor 126 handles content synchronization between desktop website 120 and the MW. In another embodiment, the MCE 108 may generate the mobile-optimized content on the fly and directly pass it to the requesting mobile device, and will be discussed in a subsequent section. The WMC server also has a system of plug-ins 118 which are independent utility software program modules capable of performing a plurality of tasks and generating a result for the user. The plug-ins may be integrated into a MW for enhancing its usefulness and utility. The plug-ins may be incorporated into a MW generated using the MCE, or may be invoked by a remote process or device at run time.

The WMC server may utilize a home grown or 3^{rd} party database of mobile device capabilities to detect if a certain web content element in the HTML document should be included for the device requesting the MW page. An example of a 3^{rd} party database is WURFL (Wireless Universal Resource File) which is a detailed database of mobile devices, their form factor information, the list of hardware features the devices can support, and the list of presentation features their browsers can support etc. The WMC uses the User Agent information contained in the http requests from the client mobile device to the web server. A User Agent header contains information about the client device environment such as the language being used to communicate with the web server, the browser being used to view the website being requested etc.

FIG. 2 is a block diagram of an exemplary system showing MCE 108 from FIG. 1 in greater detail. The MCE 210 receives input from an external web content source 208, and includes a Content Analyzer 220 which may interact with various data and/or processing components in the MCE. The Catalog of Content-sections 224 is the list of those content-sections that the MCE 108 will be looking for in the source web content. The catalog of coding methods 228 is a set of coding methods that the Content Analyzer 220 uses to identify the content-section candidates. The catalog of Heuristics 232 is a set of heuristics that the Content Analyzer 220 uses to analyze the candidate content-sections and identify the best candidate to be included in the Mobile Template. After all desired content-sections are identified, they are combined 244 into a pre-defined Mobile Template layout 240. The Optimization Process 248 performs optimization on the various elements in the content to render the content elements properly and perform faster for mobile devices including adding, removing, and modifying CSS styling. In one aspect of this invention, this optimization may happen altogether within one process step within the content analyzer 220. In another aspect, this optimization may be done through in 220, 244, and 248. The resulting MW is stored into the storage 252.

FIG. 2A represents an exemplary MW generated by the WMC system by putting together the content-sections generated by the MCE in FIG. 2. The MW content is presented as pages, where a page contains content comprising of various sections. The page is contained in the screen frame 290 which serves as the boundaries of the MW. It may contain a Header area 291 that may include a Logo 292 and a Motto or Slogan text line 293. It may also include a Banner image 294 which could be a substituted with animations such that a plurality of images may rotate to be shown one at a time by using various graphical animation methods such as horizontal image scrolling, vertical image scrolling, fading one image out and another image in etc. The MW may contain a page body 295 containing rich content such as text in various font styles, font weights, bullet list, images etc. If there is more than one page in the MW, the page may contain navigation options, also referred to as menu options, for other pages in the MW. The page may also contain a Footer 297 that contains information like site map links, copyright statements, terms of use etc. It should be noted that this arrangement is an exemplary layout of the content-sections and other arrangements may be used such as placing the navigation options above the banner part.

A web page is build based on the Document Object Model, also referred to as DOM. A DOM is a tree structure of information in a software application. A tree typically starts with a root node having a plurality of children nodes, which in turn may have their own children nodes and so on. The tree structure allows traversing of the nodes using a variety of tree-traversal algorithms, commonly used by software developers skilled in the art.

The catalog of content-sections 224 in FIG. 2 represents a set of logical content areas of a web page to be extracted and placed in the target MW. This set is based on a typical design layout that most websites follow. This includes a logo, a collection of navigation links (also known as menu), banner which may exist as a slider displaying a plurality of larger size images in a rotation in the same display area, a body area containing the page's main content, and a footer. These parts are conventionally laid out in a mobile website in the order listed above, but may be laid out differently and may include some or all content-sections listed above. Also, it should be noted that this set of content-sections is used as the most common layout, but there could be fewer or more content-sections and can be handled in the system accordingly. This organization of the content-sections will be referred to as a Mobile Template in this document.

The catalog 228 in FIG. 2 represents the possible coding methods for the various content-sections in a web page markup language such as HTML. There may be different ways of implementing the coding methods. In one embodiment, the catalog may be implemented directly in the software interleaved with other code using the typical variety of programming constructs such as “if . . . then . . . else,” switch statements, for loops etc. In another embodiment, the catalog may be built as a knowledge base or a library of various possible implementations for each content-section. As an example of coding methods, a logo may be implemented in a variety of ways such as, 1) with an image tag, 2) with the ‘background’ specification in the CSS, 3) as text embedded in an image etc. Similarly, navigation may be implemented as a collection of links. The catalog 228 may be implemented in an organized collection of records in a relational or other type of database for each lookup. This catalog is extensible and additional varieties of coding methods may be added as needed.

The catalog 232 in FIG. 2 represents a catalog of heuristics applied to find a matching coding method for each content-section in the DOM. The catalog of filtered elements 236 represents a set of elements that may be filtered out of the web page content. This may be needed if, for example, we want to remove certain parts or elements from the MW such as Flash movie objects which are not supported by some mobile devices. The application of heuristics involves a sequence of programming actions such as checking for certain HTML elements, comparing elements etc. Taking the example of logo detection, the Content Analyzer knows from the catalog of coding methods 228 that one of the coding methods for a logo is with an <img> tag. So the Content Analyzer 220 checks container elements, such as <div> for an identifier or class name with the word ‘logo’ in it. However, it is possible that the container element may have an identifier with the word logo for some other reason (or may be a substring of another word such as ‘logon’ or ‘analogous’ etc.), so the Content Analyzer checks the filename for the <img> tag within that container to see if the image filename does not suggest some other commonly used image such as a line divider, spacer, separator, or PayPal logo etc. This list can be extended with other words for more situations. If Content Analyzer cannot find a container element with the word ‘logo’, it then uses another heuristic of finding first n<img> elements in the web page document, where n can be any reasonable number in which we can typically expect to find a logo image, the idea being that a website's logo is typically visible on top of a web page, but it may not be the first, or second, or even the tenth <img> tag in the web page code. A further heuristic is to ignore any <img> tag with a logo word in it where the web address pointed (also known as a web link) to by the image points to a different website other than the website being analyzed.

As the Content Analyzer 220 process traverses and parses the DOM tree and attempts to find a match, it may find multiple possible candidates. The MCE process may record the location of any node of interest in the tree, and may annotate it for later reference.

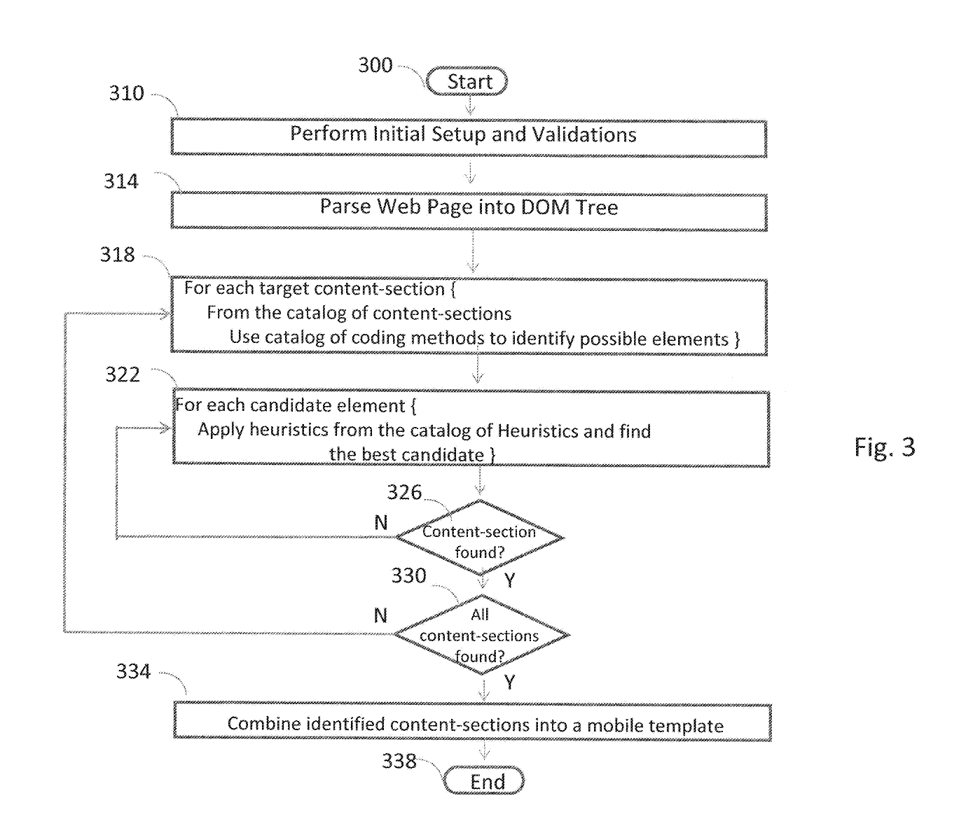

FIG. 3 represents the details of the logical flow of the processing conducted by the Content Analyzer 220. The processing starts at 300. The step 310 comprises of various activities such as analyzing an input web address of the external desktop website (in the form of a Universal Resource Locator or URL) for valid format, opening a connection to the external website, fetching the web page content from external source etc. The step 314 involves parsing the web content into a DOM tree, detecting any web page elements which are to be filtered out upfront etc. and preparing the tree for extraction of content-sections. At step 318, the Analyzer starts a processing loop with each of the target content-sections and applies each of the coding methods to the DOM elements for a match and if a match is found, it tracks that element and records it for reference. This step may generate one or more candidate elements for the current target content-section. At step 322, another processing loop starts to apply the heuristics to identify the best candidate from the list of potential candidates identified in step 318 for the current target content-section. Each of the best candidates is tracked before moving on by inserting a specific identifying marker that can be searched to locate it easily and quickly later. After all target content-sections are identified, at step 334 the MCE encodes them in a new web page using HTML syntax by combining the content-sections into the mobile template and optimize the content resulting in a MW for mobile device. The step 334 corresponds to the processes 244 and 248 in FIG. 2.

There are certain situations in which a content-section may be coded with a coding method which renders itself difficult to be accurately detectable. If none of the coding methods and/or heuristics yields a candidate for the current target content-section, the Content Analyzer 220 uses additional heuristics to find a suitable substitute that may be used for the target content-section in the resulting mobile template. As an example, if after all the processing mentioned above, a logo element is not found or matched, the Content Analyzer may decide to detect the title tag from the source HTML, and generate all combinations of the words in it, then use special techniques such as using a vocal sound matching function to pick the string that is closest to the sound of the domain name of the external web source, and use that string as a substitute. Further methods may be applied to find something that could be shown as a default for the logo content-section instead of not presenting at all, or presenting a blank area for logo in the resulting MW presented to the user.

The body content-section comprises primary informational or interactive content on a desktop website such as text, images, video, audio etc. Each of these content objects may be coded using a plurality of HTML coding elements. Filtering of specific HTML elements can be performed as desired based on the catalog of filtered elements. This is optional and may be done for a plurality of elements by default during the initial automated conversion. Once the mobile website is created by the MCE, further editing of the elements may be performed either via manual coding of the MW or using any authoring and editing tool commonly available. The body content-section is typically the heaviest content-section on a web page in most cases, and the layout of this part can be designed by the creator of the desktop web page in a variety of ways. A web page may be coded such that while elements and sections of the web page are coded in sequential order in an HTML code, the visual appearance of the elements may not necessarily follow the sequential order of the HTML code. Most existing websites and majority of new ones being created now use traditional XHTML language standards which did not specify standard naming conventions of each type of content-section, therefore detecting the body content-section is tricky since the same types of elements used in other content-sections can be used here. Additionally, there is no standard convention to designate the start and end of the body content-section. The HTML5 standard for web page coding supports the notion of specific content-sections identified with standard tags such as <nav> for navigation section, and <footer> for the footer content-section which can significantly help the content-section detection process if coded properly. However, HTML5 adoption is in early stages, and there is no enforcement of strictly following the improved standards for clear identification of various content-sections.

One approach to detecting the body content-section is to use a rigorous set of heuristics to identify the boundaries of the body content-section. This approach is less probable to yield desired result of accurate detection of body content-section due to the reasons aforementioned. In one embodiment, a set of coding methods and related heuristics may be attempted to detect the body content-section if the developer has used either clear HTML5 section tags or at least XHTML syntax where the DIV elements are assigned appropriate and meaningful identifiers such as ‘<div id=“main content”> or <div id=“page content”> etc. However, unfortunately this has not been the practice among the vast majority of website designer community. In another embodiment, a reverse approach may be taken by using the principle of exclusion i.e. everything that is not part of the other content-sections such as logo, navigation, footer etc. may be considered to be part of the main content-section. Using this approach helps in making it simple for the extraction of the content-section and also can improve the implementation, accuracy, and performance of the detection process. When Content Analyzer 220 in FIG. 2 has identified and marked the best candidate for each of the content-sections other than the body content-section, it traverses the DOM tree again to locate those markers and removes the block related to that content-section. Whatever is left is taken as the body content-section. In another embodiment, the body content-section may be further broken down into multiple sub content-sections that can be detected and placed in the target mobile template if defined for such scenarios.

The MCE may also perform other operations during the processing. One aspect of the invention is improving the performance of the live and dynamic content conversion. This may be achieved by a plurality of ways. One method is identifying a subset of pages from the external website source for initial conversion, and displaying them in an appropriate mobile-ready format in the Mobile Template. In one embodiment, the WMC Server may present the Mobile Template for user's preview, for example, in a simulator, while continuing to perform conversions of the other pages and integrating each converted mobile-friendly page with the Mobile Template seamlessly and transparently to the user.

In another embodiment, for each non-initially-converted page which may be represented by a web link, and may be presented to the user in a plurality of forms such as a menu option, an image, or a text link etc., to replace the original and standard conventional link element in the HTML code with another link construct that internally calls a special program module of the WMC system. This module takes the original web link as a parameter, opens the web page pointed to by that web link, and recursively performs formatting operations similar to the operations performed by MCE on the content-sections as it creates new code on the fly in the Mobile Template. If during the formatting operations of this web page, further web links are found, they are encoded with the same module and the link as a parameter, and so on. When the mobile website is saved, all pages may be converted and optimized for caching and serving upon requests by client devices.

This approach provides two benefits. First, it is significant improvement both from the performance of the conversion process, as well as user experience perspectives. If the external web source has a large number of pages, it allows the WMC to only convert and present an initial set of pages for preview, in a very short amount of time. Then as the user clicks on any not-yet converted page, the embedded module executes and generates a mobile optimized page on the fly, while encoding any further links on the page. Second, this allows for potentially any size of website i.e. with any number of pages, and any depth of links across those pages, to be optimized.

The serving of a mobile website generated by MCE to the mobile device can be done in a plurality of ways. In one embodiment, the generated optimized MW is cached in a Storage 114 of FIG. 1. This storage may comprise storing in either a database, or a file system or both. Upon a request from a mobile device, this MW can be loaded from the storage and returned to the mobile device. In this case, a MW is pre-built partially or fully and there is little run-time processing taking place, and therefore better performance in loading of pre-built pages is achieved. The cached MW content is kept synchronized with the external website by a Content Synchronization Processor 126. This processor periodically wakes up and compares the cached MW pages with the external desktop website page contents. The comparison may involve a variety of techniques such as calculating a bit level hash code using one or more techniques such as checksum or MD5 hash etc. commonly known in the software development practice. The comparison is performed at the content-section level i.e. the same detection method performed to detect the various content-sections during the MW generation are applied to extract the content-sections, and the aforementioned comparison techniques may be used on the content-sections of the desktop web page and the cached copy of the corresponding mobile version. If a difference is found, the respective detected content-section from the desktop web page is extracted and the cached MW page content is replaced, thus bringing the MW pages up to date.

In another embodiment, the MW could be set up to fetch one or more pages from the external webpage and perform the mobile optimization and conversion at run time. In this case, the Storage 114 may only keep the overall Mobile Template structure, necessary details and configuration to guide the runtime conversion, and styling information, and the MW pages are embedded with the program code to fetch the content from the respective desktop web page.

In one aspect of the invention, the mobile conversion engine can be used as a stand alone mobile or embedded optimization processor to extract desired content-sections from a web content source, perform conversion and optimization, and then pass the result to another process or system. The method of passing data between the MCE acting as a processor and the other systems may be performed in a variety of approaches such as a push or a pull mechanism. In a Pull mechanism, the MCE fetches any needed input from another system and performs its processing. In a Push mechanism, the MCE sends its results to another system. This type of capability can be used even on an already mobile-optimized web content as the purpose of this processing would be to perform any desired manipulation or conversion, as opposed to only mobile-optimization.

The plug-ins 118 in FIG. 1 may be a part of the WMC system and may utilize the information in the content-sections or parts of the content-sections to process for specific needs or presentation to the user in a mobile-optimized way, or may provide an independent feature. As an example, if the desktop web content has a group of images on a page and coded in a way suggesting a related group of images, those images may be detected and automatically placed into a photo-gallery or a new type of rotating slider plug-in as appropriate, depending on the form factor and browser capabilities of the mobile device. The plug-ins may be created and stored as a library of modules for easy integration for a variety of needs.

In one embodiment, the plug-ins may be locally available in the WMC and hosting environment. The local setup may provide direct integration with the MW created via the method discussed in this document. In another embodiment, the plug-ins may be set up to support secure remote access of their capability as a service. This allows the plug-in architecture to be a versatile element of the design providing extensible platform not only for the mobile websites created using WMC, but also for other external web systems to benefit from the plug-in library. In this embodiment, the plug-in may have its own user interface to design and configure an instance of the plug-in for customized use, and then store as part of the WMC Server. The storage may be part of the WMC server or may be a separate setup for scalability and reliability purposes.

This plug-in service architecture would require security and authorization mechanisms, which may be offered in a plurality of ways such as sending one or more encrypted keys or login/password to the plug-in server for authentication. The plug-in feature may be accessed by any external web application acting as a client as long as it is authenticated to use the service provided by the plug-in feature. The client application may integrate with the plug-in service using a plurality of ways that the WMC server may support, such as web service, embedding the plug-in webpage in an iframe, utilizing an Application Programming Interface, or embedding a programming script such as Javascript.

The plug-in services may comprise of a variety of implementations. In one embodiment, it may be implemented as a form requiring user input, using the user input to process and generate some result, and displaying on the client device. An example of this may be mortgage calculator.

In another embodiment, it may be implemented such that a user first creates an instance of a plug-in on WMC, configures and customizes as desired, and publish for access over the web. A good example to explain this aspect may be a survey application. The user, who may be an owner or operator of a web application or portal, wanting to utilize the survey application, may subscribe to the service, then use the WMC server user interface to create an instance of the survey application and create custom questionnaire, and publish it. The owner or operator of the web application may then integrate the survey plug-in service using one of the options aforementioned as appropriate. The integration may be transparent to the user using the client application, and available pre-integrated, or the result of the plug-in may be incorporated after a user invokes. The user option to invoke this feature on the client application may be a web address link and may take a plurality of forms such as a button, an image, or a menu option. The users using client mobile devices may then invoke the plug-in service to launch the service, which will contact the WMC server, fetch the page or content served by the plug-in service, and display on the mobile device for user interaction. The user may interact with the survey feature, and submit questionnaire input to be sent to and saved by the WMC server. The survey plug-in feature on the WMC server may have facilities to present the collected input in a report form in a variety of formats such as a table, a chart or graph. The data may remain at the WMC server and may be accessible to the subscribed owner or operator of the service.

The plug-in services system is a novel way for providing both common services needed by businesses of the same industry, as well as custom written feature for a specific customer.

I claim:

1. A system and apparatus for automated and dynamic transformation of desktop web content into a mobile-optimized web content suitable for displaying and interaction on a mobile device, comprising:
a web to mobile conversion server having a mobile conversion engine and a storage module, wherein
the mobile conversion engine is capable of creating a new mobile-optimized web content from existing desktop web content, wherein the mobile conversion engine further comprises,
a content analyzer capable of understanding and parsing the desktop website content, identifying the content-sections and manipulating it, and
wherein the content analyzer has the ability to serve as a middle layer processor between two systems, receiving web content from a source, performing the conversion, and passing the resulting mobile-optimized content to another system.

2. A method, implemented by a content analyzer, for parsing desktop web content comprising the steps of:
detecting various structural attributes;
performing a variety of computing operations on the structural attributes to extract desired content-sections; and
combining the content sections into a useful and meaningful mobile-optimized content.

3. The method of claim 2 further comprising the steps of:
fetching and parsing the external desktop content, and
converting it into a data structure to allow manipulation.

4. The method of claim 3 further comprising the steps of:
defining a configurable catalog of target content-parts to be part of a mobile website template, and looking for those content-parts in the said data structure.

5. The method of claim 4 further comprising the steps of:
identifying the content-sections in the data structure by detecting a coding method from a plurality of coding methods typically employed for each target content-section, wherein the coding methods may be implemented as an extensible catalog capable of supporting additions, variations, changes in existing and new coding methods in the catalog.

6. The method of claim 5, further comprising the steps of:
applying heuristics to accurately identify the best content-section to fit into the target content-section in the mobile template, wherein the heuristics may be implemented as an extensible catalog capable of supporting additions, variations, or changes in existing and new heuristics in the catalog or any combinations thereof.

7. The method of claim 2, wherein the method of exclusion of other content-sections, to extract the main body content-section, enabling easily and completely including the desktop page content in the mobile website.

8. The method of claim 2, further comprising the step of:
combining the content-sections into a new mobile-optimized content and placing into a mobile template.

9. The method of claim 2, further comprising the step of:
optimizing the generated content-sections for suitable viewing and for better performance on the mobile devices, wherein the mobile devices can be any form factor or screen size.

10. The method of claim 9, wherein the optimization may include optimizing assets, including images or videos or the like for lower resolution and size while retaining a good quality of the asset.

11. The method of claim 9, wherein the optimization further includes a feature of processing an initial set of pages for user review, and optimizing the remaining pages either transparently in the background, or upon clicking by a user, or when caching the mobile website for faster performance.

12. The method of claim 9, wherein optimization may include adding, removing, or modifying the CSS to produce desired effect on the content presentation style.

13. The method of claim 2 comprising substituting a modified URL link that allows for recursive mobile-optimization of any number and depth of pages.

14. The method of claim 2, further comprising the steps of:
enabling fetching a desktop content, optimizing it and presenting as mobile-optimized content on the fly instead of needing to read from a cache, thus allowing to support external web content that frequently changes and warrants a live fetch and optimization each time a client mobile device requests it.

15. The method of claim 2, further comprising an ability of performing the actions as in claim 2 on non-mobile optimized as well already mobile-optimized web content for specific purposes.

16. A method of supporting a variety of rich content features and utility tools by utilizing a plurality of plug-ins such as for image gallery, images slider, or generating advertisement flash pages or the like or any combination thereof.

17. The method of claim 16, wherein the plug-ins may be set up as remotely accessible services for access and interaction from any web based system such as a website or a web application in a secure way.

18. The method of claim 16, wherein the remotely accessible plug-ins services can be integrated into a website or application via a plurality of possible remote access means such as web services, web page coding constructs, Application Programming Interfaces, or embedded programming script or any combination thereof.

19. The method of claim 16, wherein access to the plug-in services may be secured such that a client application may only access with a secure connection such as using a provided encrypted key or username/password or any combination thereof.
